(19) United States
(12) Patent Application Publication
(10) Pub. No.: US 2013/0006771 A1
(43) Pub. Date: Jan. 3, 2013

(54) INFER LOCATION FROM PUBLISHER'S PAGE AND MATCH WITH ADVERTISERS

(76) Inventor: Jignashu PARIKH, San Jose, CA (US)

(21) Appl. No.: 13/172,494

(22) Filed: Jun. 29, 2011

(51) Int. Cl. G06Q 30/00

(52) U.S. Cl. 705/14.57

(57) ABSTRACT

An apparatus and method for inferring a geographic locus for a publisher document in order to obtain advertisements that are relevant to the inferred geographic locus. Landing pages are analyzed by determining whether the page encodes a street address and extract the street address or for information that is indicative of a geographic locus and thereby determine the geographic locus of the page. The ad server can infer a geographic locus for the publisher document based on information indicating a geographic location encoded in the publisher document, and select ads based on corresponding landing pages having inferred geographic locus that match the inferred geographic locus for the publisher document.

### BACKGROUND OF THE INVENTION

1. Technical Field

The inventive field relates to advertising in conjunction with publication of publishers Web content. In particular, the application relates to improving the relevance of advertisements and other virtual content in publisher documents, with respect to inferred locus for advertisers ads and inferred locus for the publishers Web content.

2. Background

Some websites provide an information search functionality that is based on query keywords entered by the user seeking information. This user query can be used as an indicator of the type of information of interest to the user. By comparing the user query to a list of keywords specified by an advertiser, it is possible to provide relevant advertisements to these search service users.

A publisher's Web content may not include information search functionality, but may include links to Web pages or other documents. Also, a publisher's Web content may incorporate advertisements in order to generate a source of revenue, as well as to enhance the value of their Web site.

However, selecting advertisers that may enhance value for the publishers Web site can be fairly complicated. Also, publisher documents have limited display resources, and there may be other advertisers that would be more relevant and produce better value enhancement to a publisher's Web site.

Publishers, on the other hand, may be concerned with proliferation of advertisements in their Web sites that do not enhance the value of their Web sites, but instead may be annoying to visitors browsing their Web sites. Publishers may wish to limit their Web sites to advertisements that enhance the visitors experience and motivation for visiting their site. For example, a publisher Web site that provides information about Big Sur would have its value enhanced by including advertisements about local outfitters in the publisher's Web pages.

In order to assist advertisers in producing online ads, facilities may be provided that enable advertisers to include keywords and parameters. Advertisers can provide keywords that would help their ads to be matched by search terms entered by a potential consumer. In addition, advertisers can provide preferred geographic location information so that potential consumers will be provided advertisements that pertain to a location of interest.

Provided an ad database that contains geographic location information, advertisements for a specific location area can be provided to users that are relevant to the location of the user.

However, entry of keywords and parameters such as location information by advertisers is voluntary, and may not be entered by an advertiser in creating an ad. In addition, publishers may not show a specific address, but may publish content that relates to a geographic area.

In order to expand the pool of potential advertisers that may be relevant to a publisher, an aspect is to infer a geographic locus for a publisher Web site, document or application, and a geographic locus associated with advertiser Web sites, and match potential advertisers with the publisher Web site based on geographic locus information inferred for the publisher Web site and inferred for advertisers landing pages.

### BRIEF SUMMARY

A method and apparatus including a virtual content analysis and selection component inferring a geographic locus for landing pages based on information indicating a geographic location encoded in the respective landing page, and a publisher document analyzer inferring a geographic locus for the publisher document based on information indicating a geographic location encoded in the publisher document. The virtual content analysis and selection component selecting one or more ads based on corresponding landing pages having inferred geographic locus that match the inferred geographic locus for the publisher document. An ad interface component that serves the selected ads.

A publisher's document can provide important hints on the location of the publisher or the location about which the document is written. Advertisers may not have specified a location of their business, but corresponding landing pages may provide information that indicates a possible location. By extracting information on the location of the publisher and location information from landing pages, geographic locus of a publisher and geographic locus of landing pages can be inferred. This enables content ads which pertain to a geographic locus in proximity of the publisher location to be served.

These and other aspects are described in detail with respect to the drawings.

### BRIEF DESCRIPTION OF THE SEVERAL VIEWS OF THE DRAWINGS

The teachings of the present invention can be readily understood by considering the following detailed description in conjunction with the accompanying drawings. In the drawings,

FIG. 1 is an example network configuration;

FIG. 2 is a block diagram for an ad server;

FIG. 3 is a flowchart for inferring a geographic locus for an ad from a landing page;

FIG. 4 is a flowchart for inferring a geographic locus for a Publisher Web site;

FIG. 5 is a flowchart of an exemplary method for inferring locus information for an advertiser Web site from a landing page and other pages linked either directly or indirectly from the landing page;

FIG. 6 is a flowchart of an exemplary method for inferring locus information from content of publisher Web pages, documents or applications;

FIG. 7 is a flowchart of an exemplary method for providing advertisements that are proximate to the inferred locus of a publisher Web site, document or application;

FIG. 8 is a schematic for a display layout for a publisher document having a link to an external page;

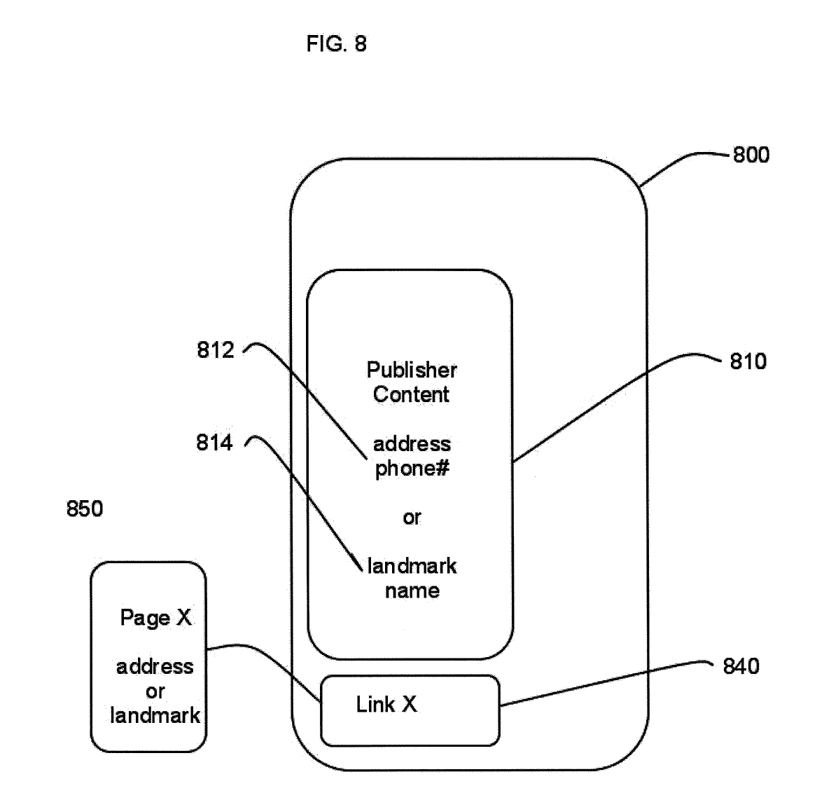

FIG. 9 is a schematic for a display layout for a publisher document having a link to an external page and embedded requests for ads;

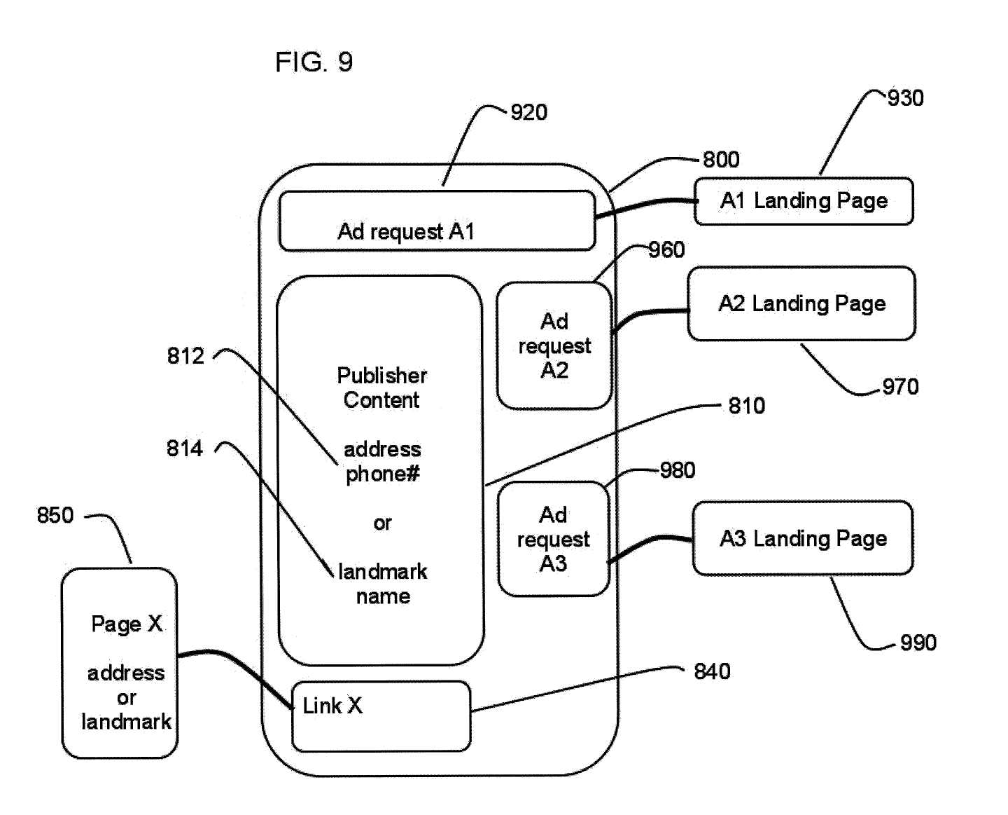

FIG. 10 is an example display for a publisher Web page having a link to an external Web page;

FIG. 11 is an example display for the external Web page for the link in FIG. 8;

FIG. 12 is an example display with online ads that have been automatically obtained;

FIG. 13 is an example script that may be inserted into a publisher Web page to automatically obtain an online ad;

FIG. 14 is an example display for a publisher Web page having an automatically inserted online ad selected based on proximity to the geographic locus inferred for the publisher Web page;

FIG. 15 is an example display for a landing page that is linked to the online ad in FIG. 12; and

FIG. 16 is a block diagram for a computing device provided as an ad server.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The following description refers to the accompanying drawings. The following description is not intended to limit the scope. Instead, the scope is defined by the appended claims.

In an example embodiment, a database of ads, or other virtual content submitted by advertisers, and a database of publisher Web site information and content can be maintained in a database system. Advertisers can be provided with an interface for creating and/or updating ads or other virtual content for storage in the ad database. Publishers can incorporate code in their Web pages, documents or applications that can retrieve ads from the ad database. The selection of ads and virtual content to be retrieved can be made by a virtual content selector. Publisher data can be obtained by a crawler that analyzes a Publisher Web site, documents or application and extracts content, information about content and geographic locus information. Landing pages associated with the database of ads can be analyzed in order to extract geographic location information for the landing pages.

### A. NETWORK ENVIRONMENT

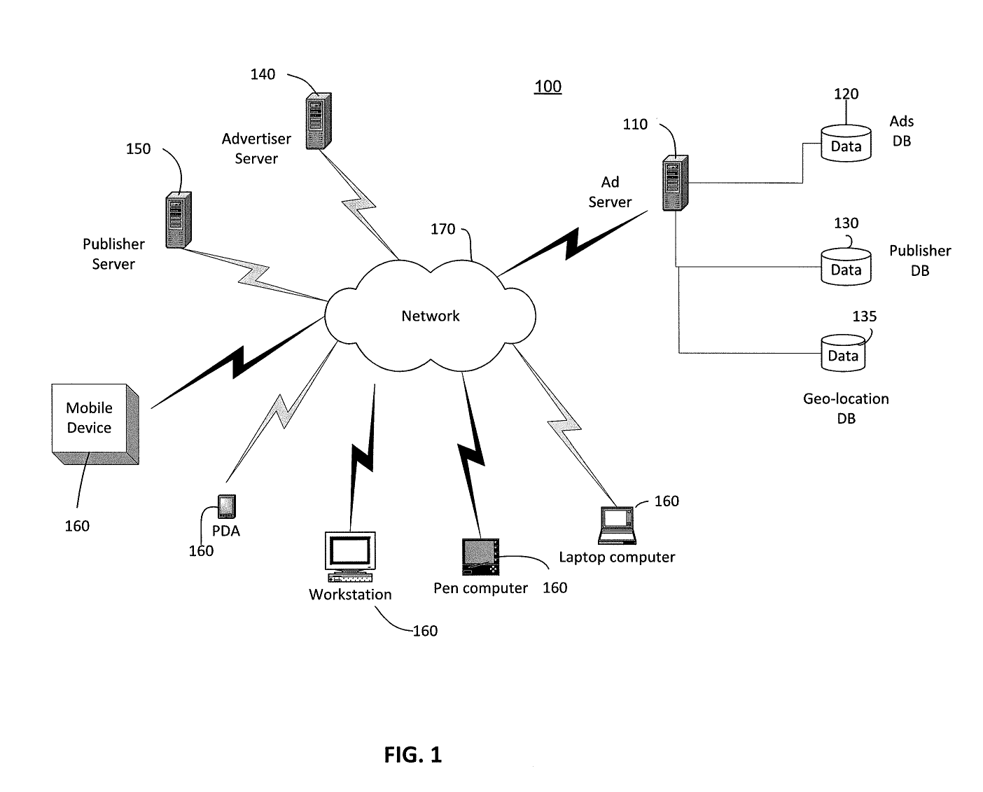

FIG. 1 is a diagram illustrating an example network environment which embodiments may be implemented. Implementations of the network environment can include a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”), a wide area network (“WAN”), e.g., the Internet, or cellular network.

The network environment in FIG. 1 includes an ad server 110, an advertiser server 140, a publisher server 150, and various user devices 160, which communicate over network 170. The ad server is in communication with a back-end database system, including an ad database system 120, a publisher database system 130, and a geo-location database system 135. Other database systems which are not shown may also be included, including a performance database system. Although only a single advertiser server 140 and a single publisher server 150 are shown for purposes of simplicity of illustration, it is understood that more than one such server may be provided. Also, publisher server 150 may be accessed through communication with user devices 160 of publishers, and an advertiser server 140 may be accessed though communication with user devices 160 of advertisers.

It is understood that advertisers may also be agencies for advertisers, and that publishers may also be developers of Web sites for publishers. In addition, advertisers may have landing pages that may also be publisher Web pages or a publisher Web site. In other words, it is possible to have online ads or at least links for the publisher Web site itself.

For purposes of this disclosure, an advertiser may be a party that directly or indirectly sells the goods or services being advertised. The advertisement (“online ad”) may exist in a variety of forms ranging from text, image, audio, audio/visual, or any other type of sensory message. Also, advertisers may distribute other virtual content, in addition to or as an alternative to ads.

The advertiser server 140 may be accessed by both the advertiser through a user device 160 and an advertisement consumer, such as a publisher. A publisher may access a publisher server 150 to incorporate online ads into a page of a publisher Web site. The online ads may be related to landing pages hosted by the advertisement server. Publisher Web pages may be provided to a user through the network 170 by way of a user device 160 using a Web browser, document or application.

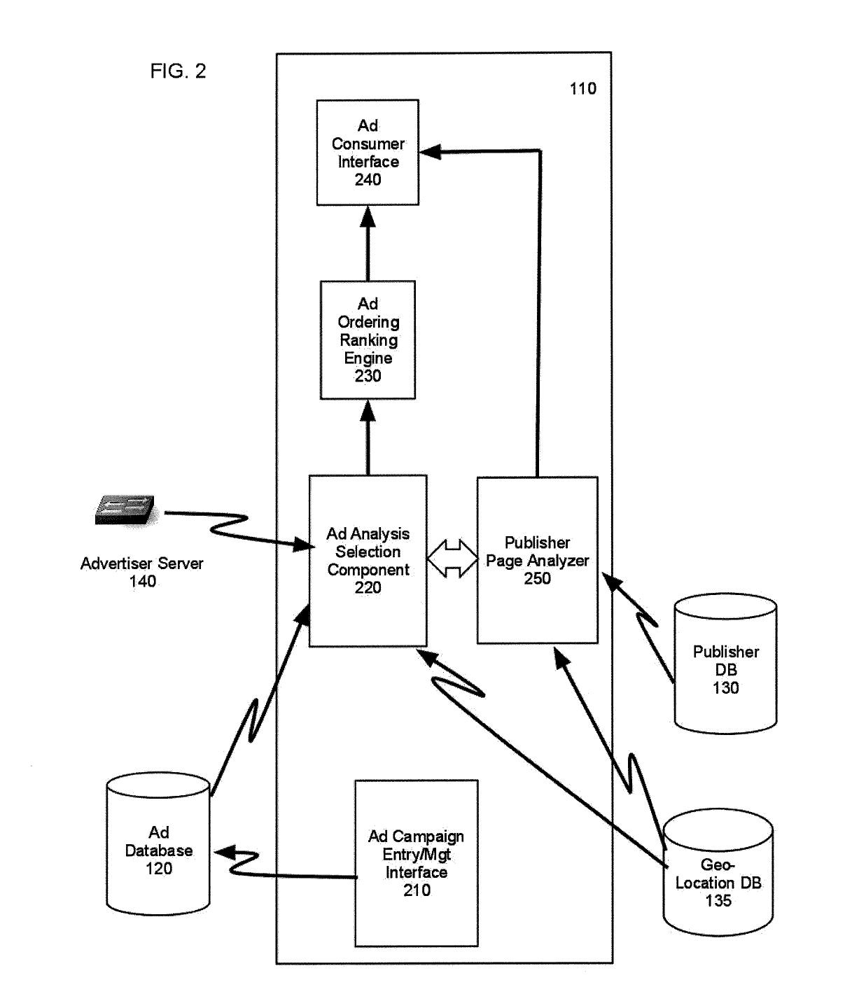

As shown in FIG. 2, the ad server 110 may include an ad entry and management interface 210. An advertiser can use the ad entry and management interface 210 to enter one or more ad creatives (otherwise known as “ads” or “advertisements”), one or more keywords associated with the creatives, geographic location information (such as a country, city, address, that represents a region of interest an online ad), and other information related to the online ad. Data entered and maintained for ad creatives are stored in the ad database system 120. The ad database system 120 may be any of a variety of data storage and retrieval systems, such as a relational database system, flat file system, extensible markup language (XML) files, as well as other data management tools, such as tools for handling big data.

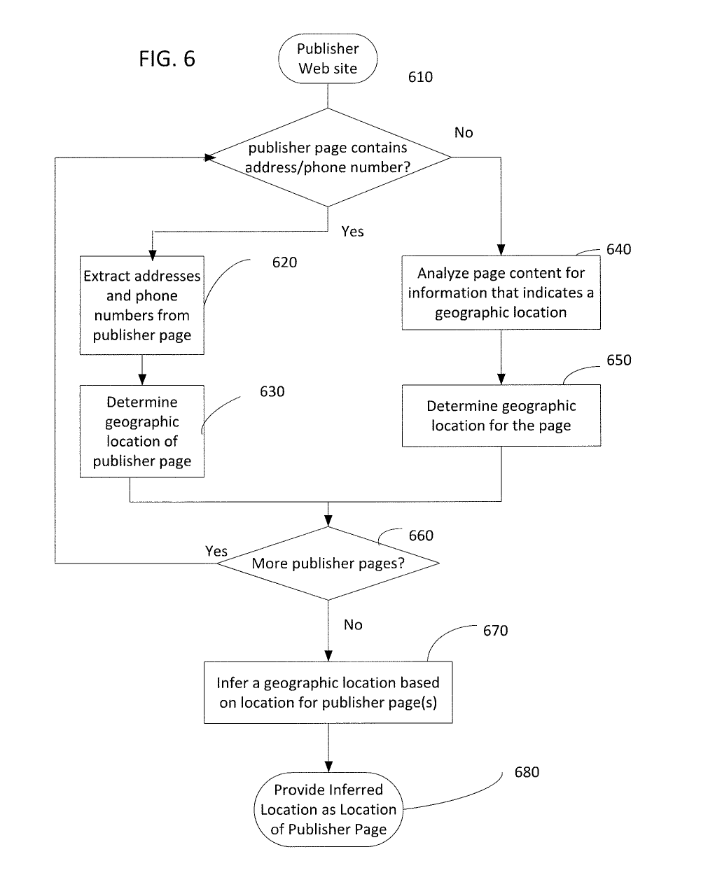

The ad server 110 also includes an ad analysis and selection component 220. FIG. 6 shows a schematic for an example of an electronic display of a publisher page or document 600. As shown in FIG. 6, the publisher page or document 600 may contain publisher content 610 a link 640 to an external Web page 650. For purposes of this disclosure, a link is a hypertext link, which when activated, retrieves a Web page addressed by the hyperlink.

The ad analysis and selection component 220 can access landing pages from the ads database 120. For landing pages that are for local businesses (i.e., businesses that have an explicit address that mention formal addresses, identified by a label “address” or in the form of an address, such as street, city, zipcode), the ad analysis and selection component 220 can extract the addresses and phone numbers. The ad analysis and selection component 220 can apply a weighting to extracted addresses. For example, address information that is repeated a number of times in a landing page can be given greater weight. When a landing page contains only one address that is repeated more than once, that address would be given greater weight than when a landing page contains a repeated address, but also contains at least one other address. On the other end of weighting, when multiple addresses are contained in a landing page, and the multiple addresses are in different regions, states, even countries, which would indicate large distances between addresses, the address information is given a relatively low weight. The ad analysis and selection component 220 can access other pages of an Advertiser's Web site from advertiser server 140. When the other pages are associated with the landing page, address information can be extracted from those other pages of the advertiser Web site. When the same address is mentioned on multiple pages, the same address is labeled as “non-ambiguous.”

For the Advertiser's Web pages that do not mention specific addresses and phone numbers, the ad analysis and selection component 220 can extract city names, names of major landmarks, and street names. For purposes of identifying city names, names of major landmarks, and street names, geo-location database 135 can be accessed. If a page mentions any of a city name, name of a landmark, street name, more than once, the page will be marked as being a local page.

The ad analysis and selection component 220 can tag (i.e., annotate) those local landing pages that have geographic location information extracted. Upon extracting geographic location information from pages, an inferred location for a landing page will be determined among all of the local pages of an Advertiser's Web site.

The ad server 110 further includes a publisher page analyzer 250. The publisher page analyzer 250 analyzes the publisher pages at the publisher Web site by extracting any explicitly mentioned addresses and phone numbers, and by searching for possible location information, such as city names, major landmarks, street names. FIG. 6 shows an example publisher Web page, document or application 600 in which content 610 may include an address/phone number 612 or landmark name 614. The publisher page analyzer 250 can determine a geographic locus for a page, document or application in the publisher page Web site. Analysis of a publisher Web site can be performed using data maintained in the publisher database system 130. For example, the publisher database system 130 can contain cached pages or documents from a publisher Web site.

Analysis of advertiser landing pages and other pages in an advertiser Web site by the ad analysis and selection component 220, and analysis of publisher pages or documents in a publisher Web site by the publisher page analysis component 250 can be performed using data obtained by a crawler. A crawler may periodically crawl a publisher Web site or advertiser Web site for updated information that may be used to populate the publisher database 130 or ads database 120, respectively.

Online ads stored in the ad database 120 can be retrieved by the ad analysis and selection component 220 based on criteria that the advertisers had chosen geo-targeting for the advertiser's inferred location. In addition, other online ads can be retrieved based on criteria that an inferred geographic location of landing pages match the inferred geographic location for the publisher document.

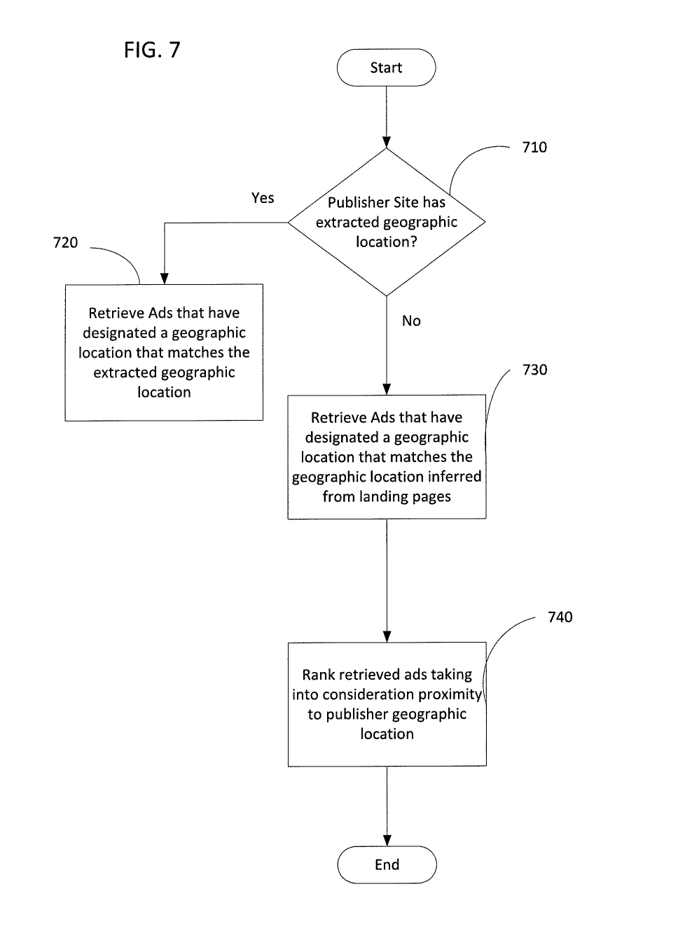

An ad ordering and ranking component 230 can rank online ads taking into account their proximity to the publisher inferred location. The ad consumer interface 240 can further evaluate the one or more ranked online ads from the ad ordering and ranking component 230 in order to provide an ad consumer such as a publisher with Web site relevant ads in accordance with a request from a publisher Web page for an automatically inserted ad. FIG. 7 shows a schematic for a publisher Web page or document 600 in which an embedded request for an ad A2 760 results in insertion of an ad A2. The inserted ad A2 may have a link to a landing page A2 770. Also shown in FIG. 7 is a request for an ad that has resulted in insertion of an ad A3 780 that has been retrieved by taking into consideration proximity to the inferred geographic locus for the publisher Web page, document or application.

### B. DEFINITIONS

“Geographic location information” may include information specifying one or more of one or more countries, one or more (inter-country) regions, one or more states, one or more metro areas, one or more cities, one or more towns, one or more boroughs, one or more areas with common zip codes, one or more areas with common telephone area codes, one or more areas served by common cable head end stations, one or more areas served by common network access points or nodes, one or more geographic areas defined by some other means, etc. It may include latitude and/or longitude, or a range thereof. Thus, for example, it may be or include an area defined by a geographic reference point and perhaps some additional information, such as a circular area of a defined radius about a point defined by latitude and longitude coordinates for example. As another example, it may be an area defined by three or more geographic reference points, such as a triangle, rectangle, pentagon, or some other polygon defined by a number of geographic reference points for example. It may also include information, such as an IP address, from which a location can be estimated.

A “Web browser” is a browser facility (such as the Google Chrome™ browser form Google Inc., the Internet Explorer™ browser from Microsoft, the Mozilla Firefox™ browser of the Mozilla Foundation, the Navigator™ browser from AOL/Time Warner, the Opera™ Web browser from Opera Software of Norway, etc.) capable of interpreting and displaying Web pages from an underlying page source code.

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user are “content” of the document. A document may include “structured data” containing both content (words, pictures, etc.) and some indication of the meaning of that content (for example, e-mail fields and associated data, XML tags and associated data, etc.). Ad spots in the document may be defined by embedded information or instructions. In the context of the Internet, a common document is a Web page. Web pages often include content and may include embedded information (such as meta information, hyperlinks, etc.) and/or embedded instructions (such as JavaScript™, etc.). In many cases, a document has a unique, addressable, storage location and can therefore be uniquely identified by this addressable location. A universal resource locator (URL), for example, is a unique address used to access information on the Internet.

“Content” from a document may be rendered on a “content rendering application or device”. Examples of content rendering applications include a Web browser, a media player (e.g., an MP3 player, a Realnetworks streaming audio file player, etc.), a viewer (e.g., an Abobe Acrobat™ pdf reader), etc.

### C. OPERATION

Advertisers can use the ad campaign entry/management interface 210 to enter an address for their business or service, or a geographic locus that they wish to target. Entry of a geographic location or address is optional. For those ads, or other virtual content, stored in the ad database 120, the ad server 110 can infer a location for ads, based on information extracted from an associated landing page, as well as other pages for the Web site associated with the landing page.

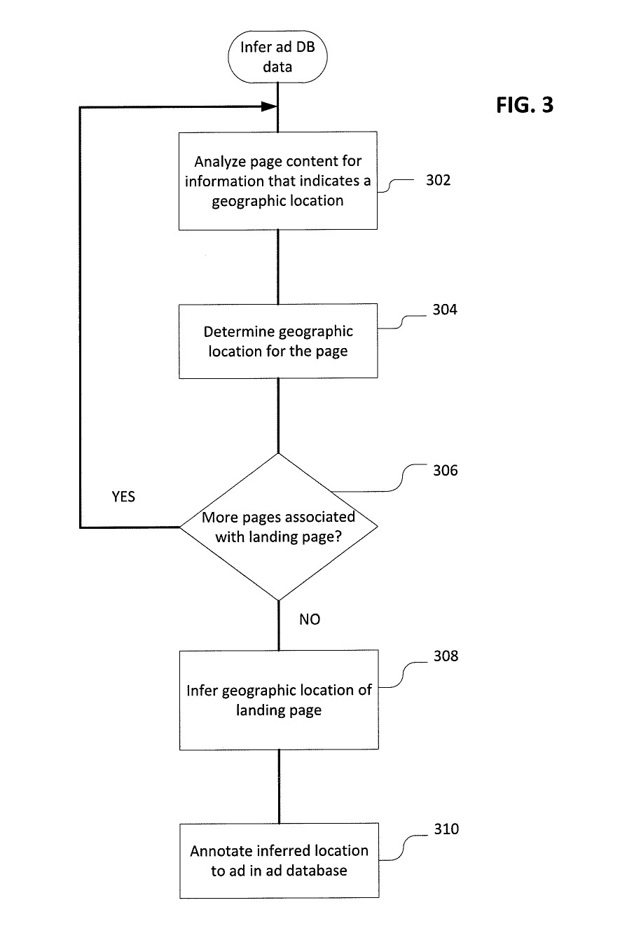

FIG. 3 shows a flowchart for an example process of inferring a geographic locus of an ad in the ad database 120. In step 302, the page is analyzed for information that indicates a geographic location. The landing page can be analyzed for words or phrases that indicate city names, major landmarks, or street names. City names, major landmarks, or street names may be extracted based on terms maintained in the geo-location database 135. In step 304, the geographic location of the landing page is determined based on the extracted location information.

In step 306, other pages are followed using the advertiser server 140 and analyzed beginning at step 302 in a similar manner in the ad analysis and selection component 220. Further links from the landing page may be followed to other pages of the advertiser Web site. In step 308, a geographic location is inferred for all pages that have been analyzed. If other addresses are incorporated in other pages of the advertiser Web site, a determination can be made as to which address is the most common. The most common address is qualified as a geographic location for the landing page. If only one address is incorporated in multiple pages of the advertiser Web site, the address is identified as being unambiguous. The unambiguous address is qualified as a geographic location associated with the landing page.

In step 310, the inferred geographic location is provided as a geographic locus of a Web site for an advertiser, an ad agency, or hosting service that is serving as a proxy for the advertiser, and is stored as an address for an ad in the ad database 120.

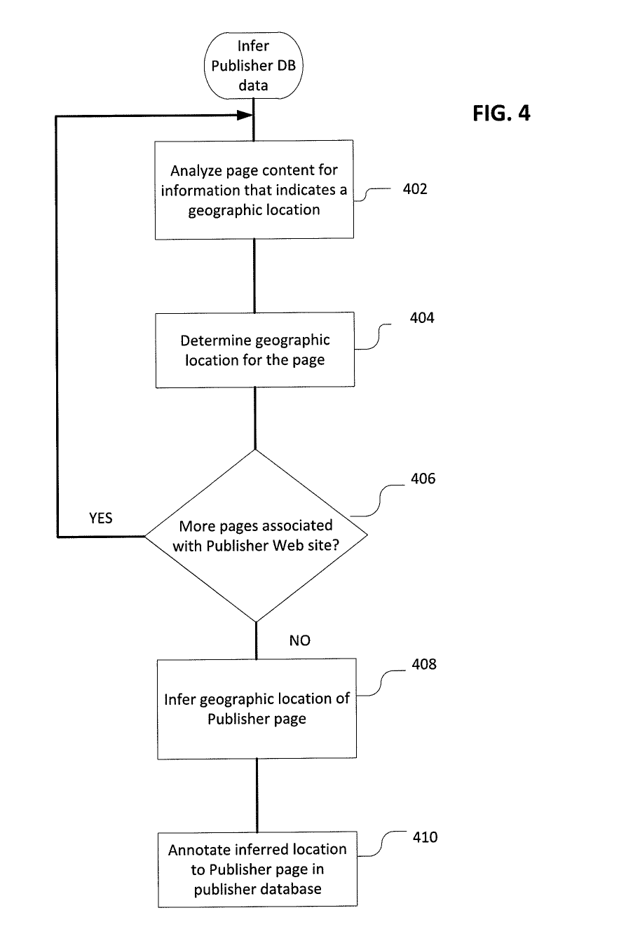

FIG. 4 is a flowchart for determining an inferred geographic locus for a publisher page, document, or application based on pages or documents in a publisher Web site. A geographic locus for the publisher Web page can be inferred in a manner similar to the analysis performed for landing pages. In step 402, the publisher page analysis component 250 determines if any city names, major landmarks, street names, are incorporated that would indicate a geographic locus. If there are multiple city names, major landmarks or street names, a geographic locus for the publisher Web page may be inferred and in step 404, qualified as a potential geographic locus.

In step 406, steps may be repeated for other publisher Web pages or documents. In step 408, the inferred geographic locus is provided as a geographic locus of a publisher page, document or application. In step 410, the inferred locus can be annotated to a publisher page, document or application stored in the publisher database 130.

Landing pages and other pages associated with a businesses Web site may contain an explicit structured address. Businesses that provide a structured address can be considered as a “local business.” In contrast, a Web site that does not provide an address may be directed to a regional, national or international audience, or otherwise has no locality information contained within its pages, and as such is not a “local business.” Publisher pages, documents or applications may be for a specific region, and may also contain an explicit structured address.

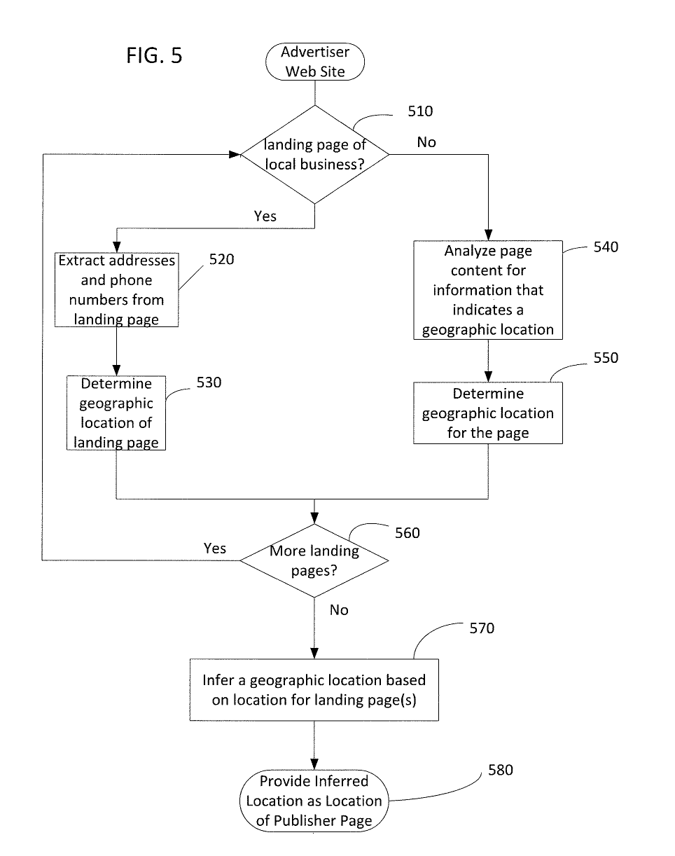

FIG. 5 is a flow diagram of an exemplary method for analyzing pages of an advertiser Web site that are for a business, product or service including cases where a advertiser is a local business. Inferred locations are annotated to the landing page of the ad.

The ad server 110 can analyze landing pages. A landing page for a local business is identified in the ad database 120 by an explicit address. An example of an explicit structured address is one that contains a label “address” or “location” followed by a standard expression for an address, such as street, city, state, and zip code. International addresses may vary in format. Alternatively, a landing page may contain an explicit address that is in a standard format for an address, but without a formal label. A phone number having a local area code may also be included in the vicinity of the address. In addition, an address, or addresses, may be located on different pages of an advertiser Web site for the local business.

Any data that is collected from Web pages and documents can be anonymized to protect individual users, through, for example, removal of personally identifying information, demographic aggregation of data, anonymization of user identifiers and/or device identifiers, and the like.

In step 510 of FIG. 5, the ad server 110 begins analysis of a landing page. In step 510, a determination is made as to whether the landing page is for a local business, i.e., incorporates an explicit address.

In step 510, when the landing page is determined to be for a local business, in step 520 the ad analysis and selection component 220 extracts the address and/or phone number and in step 530, the address is qualified as a potential geographic location associated with the landing page. In the case that the landing page incorporates a phone number, but not an address, an address can be obtained by reverse lookup on the phone number.

In step 510, when the landing page is not for a local business, i.e., does not contain an explicit structured address, step 540 is performed in the ad analysis and selection component 220. In step 540, the page is analyzed for information that indicates a geographic location. The landing page can be analyzed for words or phrases that indicate city names, major landmarks, or street names. City names, major landmarks, or street names may be extracted based on terms maintained in the geo-location database 135. In step 550, the geographic location of the landing page is determined based on the extracted location information and the landing page is tagged (annotated) as a local landing page.

In step 560, other pages are followed using the advertiser server 140 and analyzed beginning at step 510 in a similar manner in the ad analysis and selection component 220. Further links from the landing page may be followed to other pages of the advertiser Web site. The other pages may be tagged (annotated) as being a local page.

In step 570, a geographic location is inferred for all pages that have been tagged. If other addresses are incorporated in other pages of the advertiser Web site, a determination can be made as to which address is the most common. The most common address is qualified as a geographic location for the landing page. If only one address is incorporated in multiple pages of the advertiser Web site, the address is identified as being unambiguous. The unambiguous address is qualified as a geographic location associated with the landing page.

In step 580, the inferred geographic location is provided as a geographic location of a Advertiser's Web site.

FIG. 6 is a flowchart for determining an inferred geographic locus for a publisher page, document, or application based on pages or documents in a publisher Web site. In step 610, if a publisher page or document contains an explicit address/phone number, step 620 is performed in which the explicit address/phone number information is extracted and in step 630 is used to determine a possible geographic locus for the publisher page or document.

If, in step 610, a publisher Web page does not include an explicit address and/or phone number from which an address can be determined, a geographic locus for the publisher Web page can be inferred in a manner similar to the analysis performed for landing pages. In step 640, the publisher page analysis component 250 determines if any city names, major landmarks, street names, etc. are incorporated that would indicate a geographic locus. If there are multiple city names, major landmarks or street names, a geographic locus for the publisher Web page may be inferred and in step 650, qualified as a potential geographic locus.

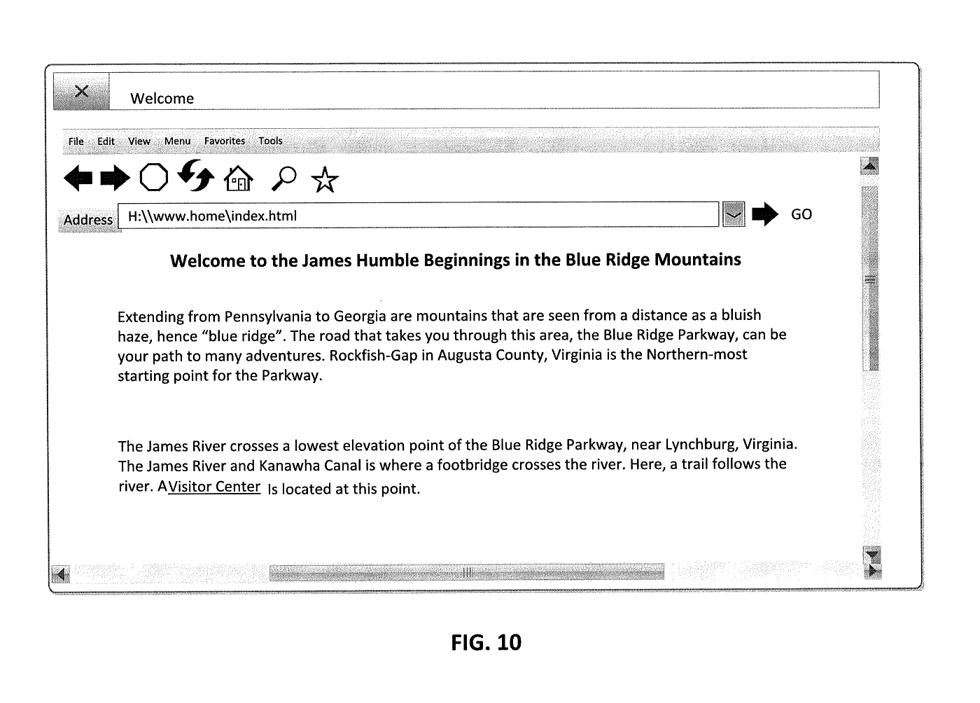

In the example publisher Web page shown in FIG. 10, a geographic locus for the publisher Web page can be inferred from the location information contained in the page, for example, location information of “Blue Ridge Mountains,” “Pennsylvania,” “Georgia,” “Blue Ridge Parkway,” “Shenandoah National Park,” “Great Smoky Mountains National Park,” “James River,” “Lynchburg,” and “Kanawha Canal.” As “James River” and “Blue Ridge Parkway” are mentioned multiple times, an inferred geographic locus for the publisher Web page may be an area where the James River and the Blue Ridge Parkway are in common.

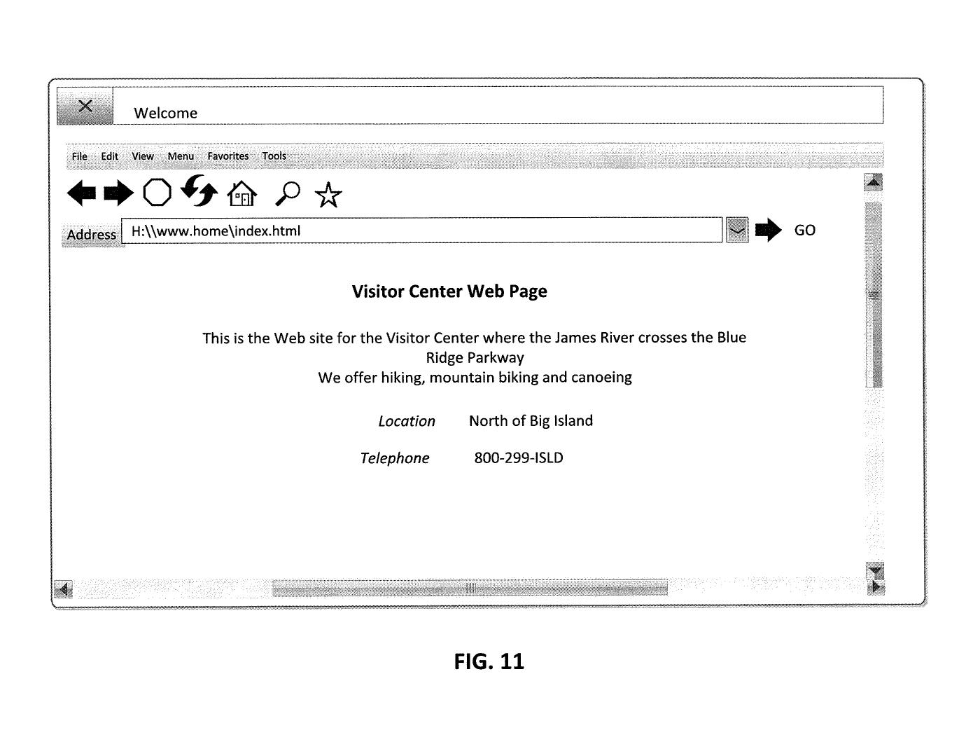

In step 660, steps may be repeated for other publisher Web pages or documents. FIG. 11 shows an example of another publisher Web page at the publisher Web site. The Web page in FIG. 11 includes an explicit location label and telephone label. The location “North of Big Island,” may be inferred as the location for the other publisher Web page. In step 670, a geographic locus is inferred for all analyzed pages of a publisher Web site. In step 680, the inferred geographic locus is provided as a geographic locus of a publisher page, document or application.

FIG. 7 is a flowchart for retrieving relevant ads and ranking retrieved ads taking into consideration proximity to publisher geographic locus. The process in FIG. 7 can use location data in the ad database 120 resulting from the process in FIG. 3 and locus data in the publisher database 130 resulting from the process in FIG. 4. In step 710, if a publisher Web site has an extracted geographic locus, step 720 can be performed in which online ads can be retrieved from the ad database system 120 for ads that have designated geographic targeting for a specific geographic locus. In addition, in step 710, if a publisher Web site does not include an explicit address or phone number from which a geographic locus can be extracted, step 730 can be performed in which online ads can be retrieved from the ad database system 120 based on the inferred geographic location for the tagged advertiser landing pages.

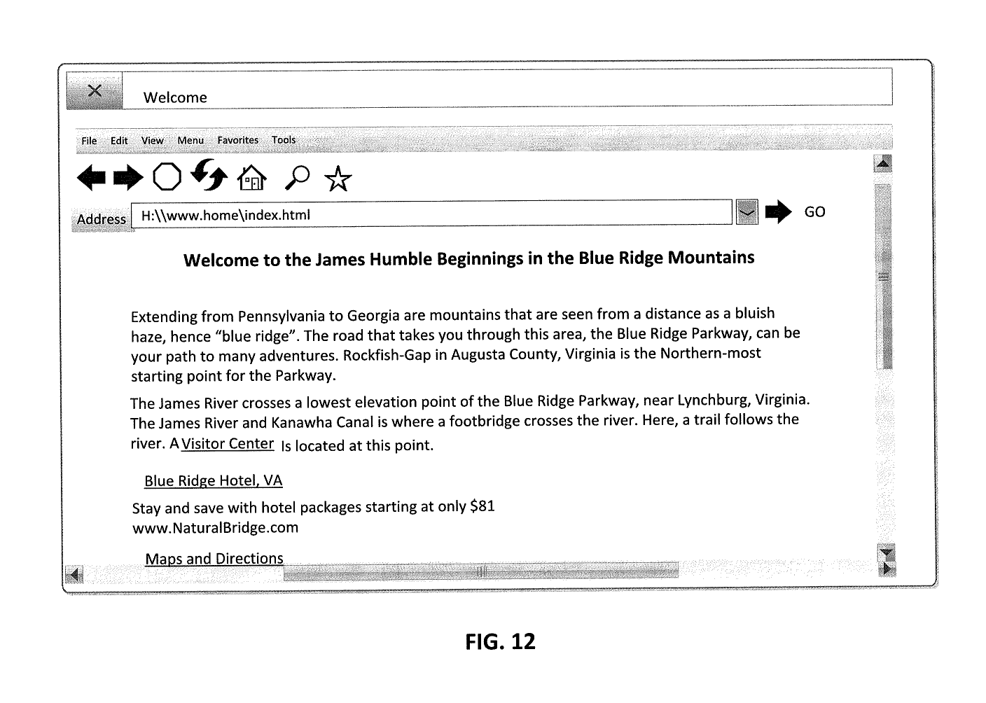

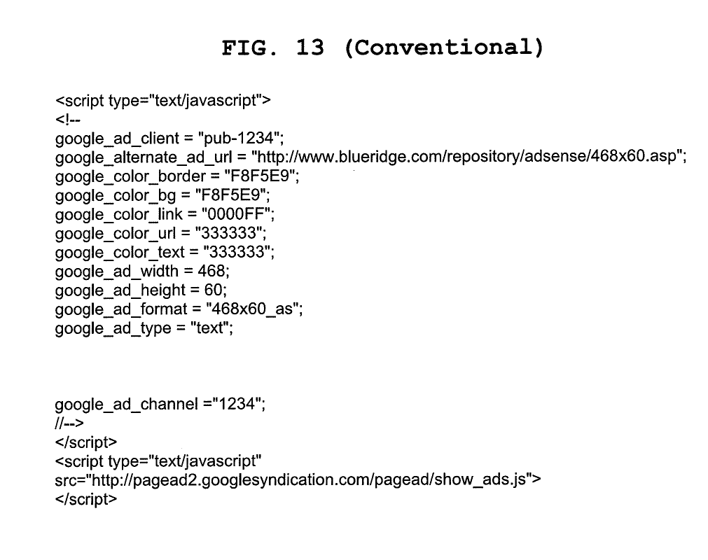

In the example display shown in FIG. 12, online ads have been automatically inserted into the publisher Web page. Online ads are obtained from the ad database system 120 based on criteria such as relevance to the content in the publisher Web page. The ad consumer interface 240 can insert a selected online ad(s) for insertion based on a request from the publisher Web page for ad(s). FIG. 13 shows an example of a type of script that may be incorporated into the code for the publisher Web page. The script designates parameters used in display of an online ad and an address to which the request for an ad(s) is sent. Although the example script is Javascript, one of ordinary skill would understand that other locally executable programs may be used instead to accomplish the same functions.

In step 740, the retrieved online ads can be ranked in the ad ordering and ranking component 230 based on proximity to the publisher geographic location. The online ads ranked based on proximity can be evaluated based on other criteria such as relevance to content of the publisher Web page by the ad consumer interface 240, to be automatically inserted into the publisher Web page for display to a user at a user device 160.

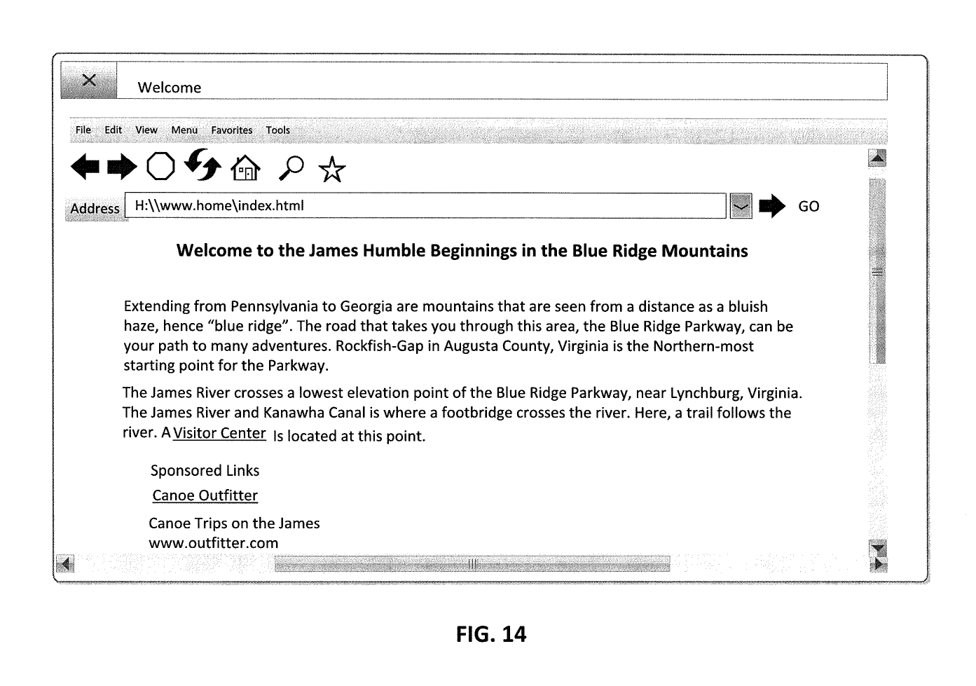

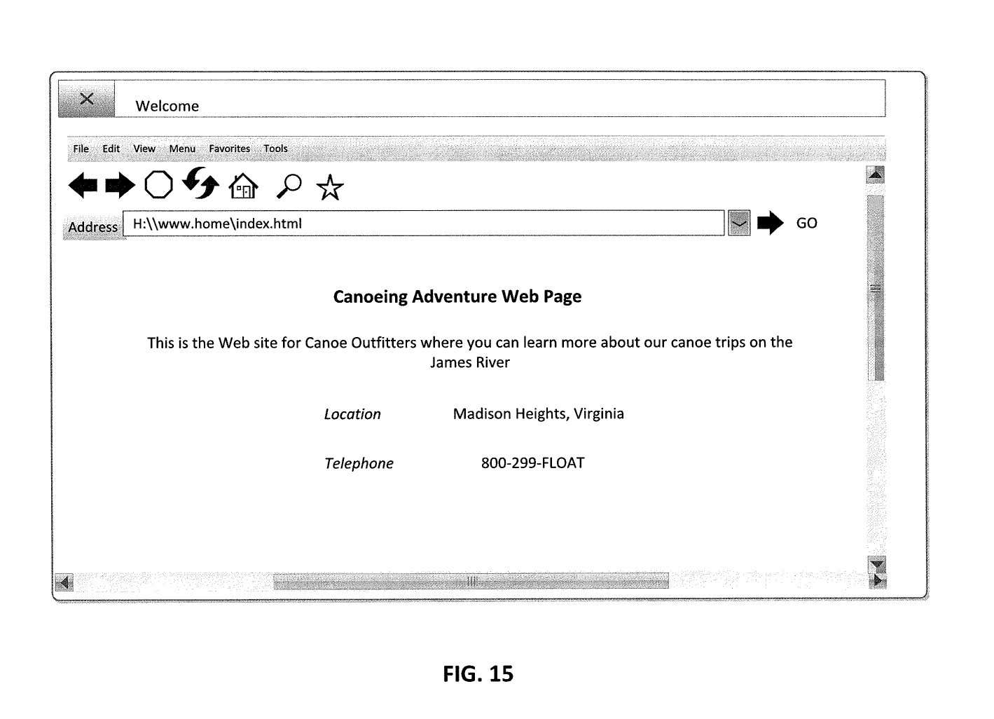

Further according to the example, the ad analysis and selection section 220 can use the inferred location of “James River” and “Blue Ridge Parkway” to retrieve online ad(s) from ad database system 120. In the example display shown in FIG. 14, an online ad for “Canoe Outfitter” is inserted into the publisher Web page. A landing page for the “Canoe Outfitter,” shown in FIG. 15, indicates that the location is Madison Heights, Virginia, which is a town outside of Lynchburg, located along the James River in the vicinity of where the Blue Ridge Parkway crosses the James River. Thus, the ad analysis and selection component 220 has retrieved an online ad that may otherwise have not been considered for insertion into the publisher Web page, thereby expanding the pool of ads that can be considered for insertion.

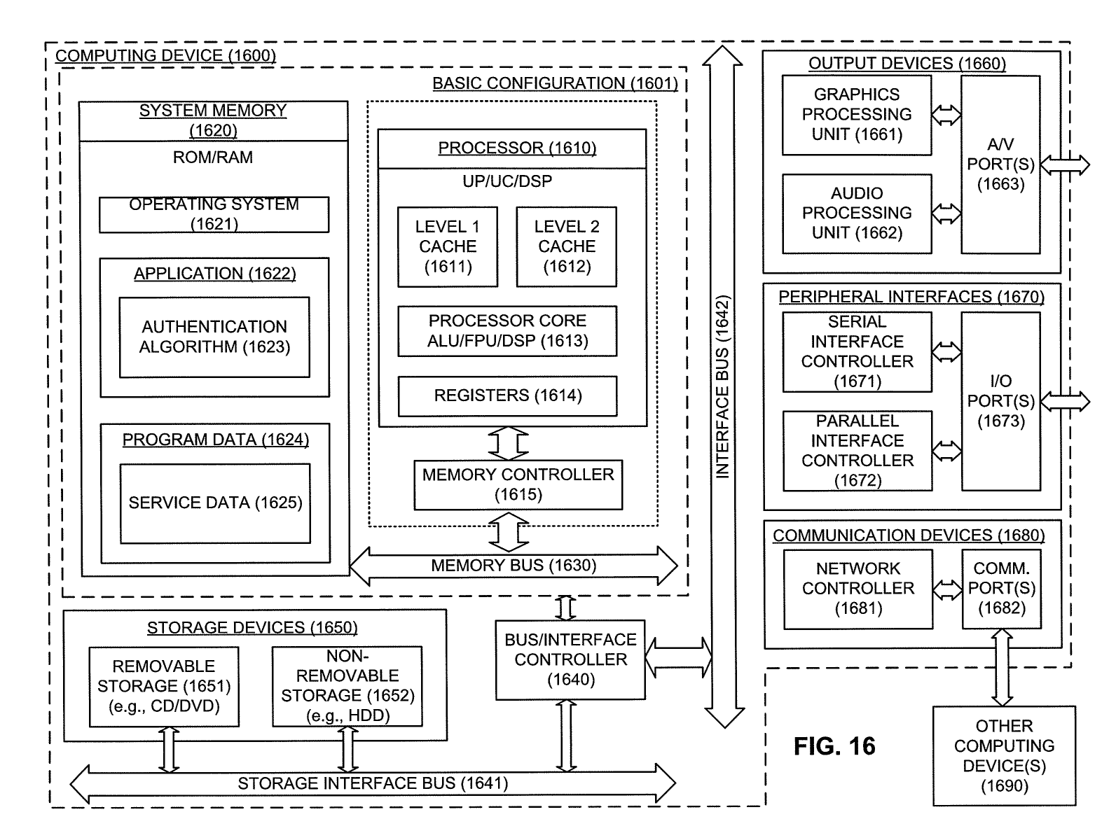

FIG. 16 is a block diagram illustrating ad server 110 configured as computing device 1600 that is arranged for inferring location from landing pages and matching with publisher's page in accordance with the present disclosure. In a very basic configuration 1601, computing device 1600 typically includes one or more processors 1610 and system memory 1620. A memory bus 1630 can be used for communicating between the processor 1610 and the system memory 1620.

Depending on the desired configuration, processor 1610 can be of any type including but not limited to a microprocessor (μP), a microcontroller (μC), a digital signal processor (DSP), or any combination thereof. Processor 1610 can include one more levels of caching, such as a level one cache 1611 and a level two cache 1612, a processor core 1613, and registers 1614. The processor core 1613 can include an arithmetic logic unit (ALU), a floating point unit (FPU), a digital signal processing core (DSP Core), or any combination thereof. A memory controller 1615 can also be used with the processor 1610, or in some implementations the memory controller 1615 can be an internal part of the processor 1610.

Depending on the desired configuration, the system memory 1620 can be of any type including but not limited to volatile memory (such as RAM), non-volatile memory (such as ROM, flash memory, etc.) or any combination thereof. System memory 1620 typically includes an operating system 1621, one or more applications 1622, and program data 1624. Application 1622 includes a algorithm 1623 for inferring location from landing pages and matching with publisher's page. Program Data 1624 includes location data 1625. In some embodiments, application 1622 can be arranged to operate with program data 1624 on an operating system 1621. This described basic configuration is illustrated in FIG. 16 by those components within dashed line 1601.

Computing device 1600 can have additional features or functionality, and additional interfaces to facilitate communications between the basic configuration 1601 and any required devices and interfaces. For example, a bus/interface controller 1640 can be used to facilitate communications between the basic configuration 1601 and one or more data storage devices 1650 via a storage interface bus 1641. The data storage devices 1650 can be removable storage devices 1651, non-removable storage devices 1652, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 1620, removable storage 1651 and non-removable storage 1652 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1600. Any such computer storage media can be part of device 1600.

Computing device 1600 can also include an interface bus 1642 for facilitating communication from various interface devices (e.g., output interfaces, peripheral interfaces, and communication interfaces) to the basic configuration 1601 via the bus/interface controller 1640. Example output devices 1660 include a graphics processing unit 1661 and an audio processing unit 1662, which can be configured to communicate to various external devices such as a display or speakers via one or more A/V ports 1663. Example peripheral interfaces 1670 include a serial interface controller 1671 or a parallel interface controller 1672, which can be configured to communicate with external devices such as input devices (e.g., keyboard, mouse, pen, voice input device, touch input device, etc.) or other peripheral devices (e.g., printer, scanner, etc.) via one or more I/O ports 1673. An example communication device 1680 includes a network controller 1681, which can be arranged to facilitate communications with one or more other computing devices 1690 over a network communication via one or more communication ports 1682. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 1600 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 1600 can also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of obtaining one or more content items that are to be displayed in a publisher document and that are relevant to a geographic locus of a publisher document, the one or more content items are linked to one or more landing pages, the method being performed in a content server, the method comprising:
inferring a geographic locus for the publisher document based on information indicating a geographic location encoded in the publisher document;
selecting at least one content item based on a landing page having a geographic locus that matches the inferred geographic locus for the publisher document; and
serving the selected content item for display in the publisher document.

2. The method of claim 1, further comprising inferring a geographic locus for landing pages based on information indicating a geographic location encoded in the respective landing pages, said inferring a geographic locus for landing pages including:
performing an analysis for pages of a Web site associated with a landing page by
analyzing the pages for information that is indicative of a geographic location and thereby determine the geographic locus of the pages;
inferring a geographic locus of the landing page based on the analysis for pages of the Web site associated with the landing page.

3. The method of claim 1, further comprising inferring a geographic locus for landing pages based on information indicating a geographic location encoded in the respective landing pages, wherein said step of inferring a geographic locus for landing pages includes extracting an address from the landing page.

4. The method of claim 1, further comprising inferring a geographic locus for landing pages based on information indicating a geographic location encoded in the respective landing pages, wherein a landing page for an advertisement comprises links to other pages of a Web site, wherein information that is indicative of a geographic location includes a street address, wherein said step of inferring a geographic locus for the landing page includes extracting the most common street address as the geographic locus for the landing page.

5. The method of claim 1, further comprising inferring a geographic locus for landing pages based on information indicating a geographic location encoded in the respective landing pages,
wherein the information that indicates a geographic locus in a landing page includes city names, major landmarks, and street names, and the ad server analyzes the landing pages for city names, major landmarks, and street names;
wherein the page containing a plurality of city names, major landmarks, and/or street names is tagged as a local page, and the ad server infers the geographic locus of the page from the most common city name, major landmark, and/or street name.

6. The method of claim 2, wherein the step of analyzing the page includes analyzing the page to determine whether the page encodes a phone number, and determining the street address from the phone number.

7. The method of claim 1,
wherein the publisher document is part of a publisher Web site,
wherein the step of inferring a geographic locus for a publisher document further comprises:
inferring information indicating a geographic locus for the publisher document from city names, major landmarks, and/or street names included in other pages of the publisher Web site, and
wherein a geographic locus for the publisher document is inferred as the most common of city name, major landmark, and/or street name.

8. The method of claim 1, wherein said content items are ads, the method further comprising a step of retrieving ads from an ad database system that match the inferred geographic locus for the publisher document.

9. The method of claim 8, further comprising a step of ranking the retrieved ads based on proximity of geographic locus for the ads to the geographic locus for the publisher document.

10. The method of claim 8, further comprising inferring geographic locus for ads in the ad database that do not designate a street address using information indicating a geographic location included in landing pages associated with the ads.

11. An apparatus comprising:
a publisher document analyzer that infers a geographic locus for a publisher document based on information indicating a geographic location encoded in the publisher document;
a content items database storing one or more content items linked to one or more pages;
a content selection component selecting at least one content item from the content items database based in part on a page having a geographic locus that matches the inferred geographic locus for the publisher document;
and
a content item interface component that serves the selected content item for display in the publisher document.

12. The apparatus of claim 11,
wherein the one or more pages linked to content items are landing pages, wherein the content selection component performs an analysis for pages of a Web site linked with a landing page by analyzing the pages for information that is indicative of a geographic location and thereby determining the geographic locus of the pages, and inferring a geographic locus of the landing page based on the analysis for pages of the Web site linked with the landing page.

13. The apparatus of claim 11,
wherein the one or more pages linked to content items are landing pages, wherein the content selection component obtains a geographic locus for a landing page of a local business by extracting an address from the landing page.

14. The apparatus of claim 11,
wherein the one or more pages linked to content items are landing pages, wherein a landing page comprises links to other pages of a Web site, wherein information that is indicative of a geographic location includes a street address, wherein the content analysis and selection component infers a geographic locus for the landing page by extracting the most common street address within the landing page as the geographic locus for the landing page.

15. The apparatus of claim 11,
wherein the information that indicates a geographic locus includes city names, major landmarks, and street names, and the content selection component analyzes the pages for city names, major landmarks, and street names; wherein the content selection component annotates the page containing a plurality of city names, major landmarks, and/or street names as a local page and infers the geographic locus of the page from a city name, major landmark, and/or street names within the page.

16. The apparatus of claim 11,
wherein the content analysis and selection component analyses the page to determine whether the page encodes a phone number, and determines the street address associated with the page from the phone number.

17. The apparatus of claim 11,
wherein the publisher document is part of a publisher Web site, wherein the publisher document analyzer infers a geographic locus for a publisher document by inferring information indicating a geographic locus for the publisher document from city names, major landmarks, and/or street names included in other pages of the publisher Web site, and infers as a geographic locus, the most commonly occurring of city name, major landmark, and/or street name within the publisher document.

18. (canceled)

19. The apparatus of claim 11, wherein the selection criteria is proximity, the apparatus further comprising an ad ranking component that ranks the retrieved content items based on proximity of geographic locus for the ads to the geographic locus for the publisher document.

20. (canceled)

21. The method of claim 1, wherein the content items are ads, and the step of selecting includes selecting one or more ads based on landing pages having a geographic locus that match the inferred geographic locus for the publisher document.

22. The apparatus of claim 11, wherein the content items are ads and wherein the content analysis portion infers geographic locus for ads that are stored without a street address.
